(19) United States
(12) Patent Application Publication
(10) Pub. No.: US 2026/0259348 A1
(43) Pub. Date: Sep. 3, 2026

(54) ROAD SAFETY SYSTEM INCLUDING MULTIPLE ROAD MARKERS PROVIDING ROAD HAZARD INFORMATION ON FOG AND ICING

(71) Applicant: KJ SYSTEM, Suwon-si (KR)

(72) Inventors: Junhyuk CHA, Suwon-si (KR); Juncheol CHA, Suwon-si (KR)

(73) Assignee: KJ SYSTEM, Suwon-si (KR)

(21) Appl. No.: 19/549,476

(22) Filed: Feb. 25, 2026

(30) Foreign Application Priority Data
Feb. 28, 2025 (KR) 10-2025-0026857

(51) Int. Cl. G01W 1/06; E01F 9/30; E01F 9/40; E01F 9/615; G08G 1/095

(52) U.S. Cl. CPC G01W 1/06; E01F 9/30; E01F 9/40; E01F 9/615; G08G 1/095

(57) ABSTRACT

A road safety system includes: a plurality of road markers installed on a road, and configured to generate humidity data by measuring air humidity and generate temperature data by measuring air temperature; and a server configured to receive the humidity data and the temperature data from each of the plurality of road markers, generate fog occurrence information indicating that an atmospheric state around the road satisfies a fog occurrence condition on the basis of the humidity data and the temperature data, and generate icing occurrence information indicating that a surface of the road satisfies an icing occurrence condition on the basis of the humidity data and the temperature data, wherein each of the plurality of road markers outputs fog alert light when the fog occurrence information is received from the server and outputs icing alert light when the icing occurrence information is received from the server.

### CROSS-REFERENCE TO RELATED APPLICATION

This application claims the benefit of and priority to Korean Patent Application No. 10-2025-0026857, filed on Feb. 28, 2025, the entire disclosure(s) of which is hereby incorporated herein by reference in its entirety.

### BACKGROUND

### Field

The present disclosure relates to a road safety system including multiple road markers providing road hazard information on fog and icing. More specifically, the present disclosure relates to a road safety system in which a server determines whether the atmospheric state around a road satisfies a fog occurrence condition and whether the surface of the road satisfies an icing occurrence condition on the basis of air humidity and air temperature around the road measured by a plurality of road markers and the plurality of road markers output fog alert light indicating occurrence of fog and icing alert light indicating occurrence of icing in accordance with the result of the determination, thereby enabling prevention of accidents that may occur due to fog and icing.

### Description of Related Art

Various technologies have been developed to improve safety and efficiency of road traffic. In particular, a technology that identifies road information in real time and controls the operation of road markers on the basis of the road information is gaining attention as an important approach to preventing road accidents and facilitating traffic flow.

Existing road markers could identify only a portion of road information and thus could not provide various data necessary required for their operation. As a result, it was difficult to perform control suitable for vehicle driving states, and there was a problem that it was difficult to sufficiently secure road safety.

In addition, a method of emitting light continuously for a certain time or of operating a light source through simple manual control is typically used in existing road markers. However, such a method has a limitation that it cannot provide an immediate response to changes in the road environment.

### [Prior Art Document]

### [Patent Document]

Korean Patent No. 10-0705672

### SUMMARY

An objective of the present disclosure is to provide a road safety system in which a server determines whether the atmospheric state around a road satisfies a fog occurrence condition and whether the surface of the road satisfies an icing occurrence condition on the basis of air humidity and air temperature around the road measured by a plurality of road markers and the plurality of road markers output fog alert light indicating occurrence of fog and icing alert light indicating occurrence of icing in accordance with the result of the determination, thereby enabling prevention of accidents that may occur due to fog and icing.

The objectives of the present disclosure are not limited to those described above and other objectives and advantages not stated herein can be understood from the following description and will be more clearly understood through the embodiments of the present disclosure. Further, it will be readily understood that the objectives and advantages of the present disclosure can be realized by the means set forth in the claims and combinations thereof.

A road safety system according to an embodiment of the present disclosure includes: a plurality of road markers installed on a road, and configured to generate humidity data by measuring air humidity and generate temperature data by measuring air temperature; and a server configured to receive the humidity data and the temperature data from each of the plurality of road markers, generate fog occurrence information indicating that an atmospheric state around the road satisfies a fog occurrence condition on the basis of the humidity data and the temperature data, and generate icing occurrence information indicating that a surface of the road satisfies an icing occurrence condition on the basis of the humidity data and the temperature data, wherein each of the plurality of road markers outputs fog alert light when the fog occurrence information is received from the server and outputs icing alert light when the icing occurrence information is received from the server.

The server may generate average humidity data representing an average humidity between air humidities represented by any two or more pieces of humidity data among the plurality of humidity data, and generate average temperature data representing an average temperature between air temperatures represented by any two or more pieces of temperature data among the plurality of temperature data.

The server may generate dew point data representing a dew point using the average humidity data and the average temperature data, and when the average humidity represented by the average humidity data exceeds a preset fog occurrence condition humidity and a dew point temperature difference, which is a difference between the dew point represented by the dew point data and an average temperature represented by the average temperature data, falls within a preset fog occurrence temperature difference range, the server may determine that the atmospheric state of the road satisfies the fog occurrence condition, and generate the fog occurrence information.

The server may identify marker identification information of a road marker corresponding to the average humidity or the average temperature used to determine that the atmospheric state of the road satisfies the fog occurrence condition, and transmit the fog occurrence information to the road marker indicated by the identified marker identification information.

The server may generate surface temperature data representing a surface temperature of the road by reducing an average temperature represented by the average temperature data by a preset reduction temperature, and when the average humidity represented by the average humidity data exceeds a preset icing occurrence condition humidity and the surface temperature represented by the surface temperature data is lower than a preset icing reference temperature, the server may determine that the surface of the road satisfies the icing occurrence condition, and generate the icing occurrence information.

The server may identify marker identification information of a road marker corresponding to the average humidity or the average temperature used to determine that the surface of the road satisfies the icing occurrence condition, and transmit the icing occurrence information to the road marker indicated by the identified marker identification information.

The plurality of road markers may include: a sensor unit including a humidity sensor configured to measure air humidity and a temperature sensor configured to measure air temperature; and a light emitting unit configured to output one or more of fog alert light and icing alert light.

According to the present disclosure, a server determines whether the atmospheric state around a road satisfies a fog occurrence condition and whether the surface of the road satisfies an icing occurrence condition on the basis of air humidity and air temperature around the road measured by a plurality of road markers and the plurality of road markers output fog alert light indicating occurrence of fog and icing alert light indicating occurrence of icing in accordance with the result of the determination, thereby enabling prevention of accidents that may occur due to fog and icing.

### BRIEF DESCRIPTION OF THE DRAWING

The aspects, features, and advantages of specific embodiments of the present disclosure will become more apparent through the following description with reference to the accompanying drawings.

FIG. 1 is a view illustrating a connection configuration between a plurality of road markers and a server included in a road safety system according to an embodiment of the present disclosure.

FIG. 2 is a block diagram of a plurality of road markers included in a road safety system according to an embodiment of the present disclosure.

FIG. 3 is a perspective view of a plurality of road markers included in a road safety system according to an embodiment of the present disclosure.

FIG. 4 is a block diagram of a server included in a road safety system according to an embodiment of the present disclosure.

FIG. 5 is a view illustrating a process in which a server included in a road safety system according to an embodiment of the present disclosure generates fog notification information and icing notification information.

FIG. 6 is a view illustrating a process in which a server included in a road safety system according to another embodiment of the present disclosure generates traffic situation information.

### DETAILED DESCRIPTION

The embodiments may be subject to various modifications and may be implemented in various forms, so that specific embodiments are illustrated in the drawings and will be described in detail in the detailed description. However, this is not intended to limit the scope to specific embodiments and should be construed as including various modifications, equivalents, and/or alternatives of the embodiments of the present disclosure. In the description of drawings, similar reference numerals may be used for similar components.

In describing the present disclosure, detailed descriptions of related well-known functions or configurations will be omitted when such descriptions are determined to unnecessarily obscure the subject matter of the present disclosure.

In addition, the following embodiments may be modified in various forms, and the scope of the spirit of the present disclosure is not limited to these embodiments. Rather, these embodiments are provided so that the present disclosure is more complete and the spirit of the present disclosure can be fully conveyed to those skilled in the art.

The terminology used in the present disclosure is used only for the purpose of describing specific embodiments and is not intended to limit the scope of the claims. Singular forms are intended to include plural forms unless the context clearly indicates otherwise.

In the present disclosure, expressions such as “have,” “may have,” “include,” or “may include” indicate the presence of corresponding features (e.g., a numerical value, a function, an operation, or a component such as a part) and do not exclude the presence of additional features.

In the present disclosure, expressions such as “A or B,” “at least one of A and/or B,” or “one or more of A, B and/or C” are intended to include all possible combinations of the listed items. For example, “A or B,” “at least one of A and B,” or “at least one of A or B” may refer to all of a case (1) including at least one A, a case (2) including at least one B, or a case (3) including both of at least one A and at least one B.

The expressions such as “first” and “second” used in the present disclosure may modify various components regardless of the order and/or priority and are used only to distinguish one component from another component without limiting the components.

When a component (e.g., a first component) is “operatively or communicatively coupled with/to or connected to” another component (e.g., a second component), it should be understood that the component may be connected to another component directly or through another component (e.g., a third component).

However, when a component (e.g., a first component) is “directly coupled to” or “directly connected” to another component (e.g., a second component), it may be understood that no other component (e.g., a third component) exists between the component and the other component.

The expressions “configured (or set) to” used in the present disclosure may be replaced, for example, with “suitable for”, “having the capacity to”, “designed to”, “adapted to”, “made to”, or “capable of”, depending on circumstances. The term “configured (set) to” may not necessarily mean only “specifically designed to” in terms of hardware.

Instead, in some cases, the expression “a device (road marker, server) configured to ~” may mean that the device “can perform ~” together with other devices or components. For example, the phrase “a processor configured (or set) to perform A, B, and C” may refer to a dedicated processor (e.g., an embedded processor) for performing the operations, or a general-purpose processor (e.g., a CPU or an application processor) that can perform the operations by executing one or more software programs stored in a memory device.

In the embodiments, “~module” or “~unit” performs at least one function or operation and can be implemented in hardware, in software, or in a combination of hardware and software. Further, a plurality of “modules” or a plurality of “units” may be integrated into at least one module and implemented by at least one processor except for “modules” or “units” required to be implemented in specific hardware.

Meanwhile, various elements and regions in the drawings are schematically illustrated. Accordingly, the spirit of the present disclosure is not limited by relative sizes or spacings illustrated in the accompanying drawings.

Hereinafter, embodiments of the present disclosure will be described in detail with reference to the accompanying drawings for those skilled in the art to be able to easily implement the present disclosure.

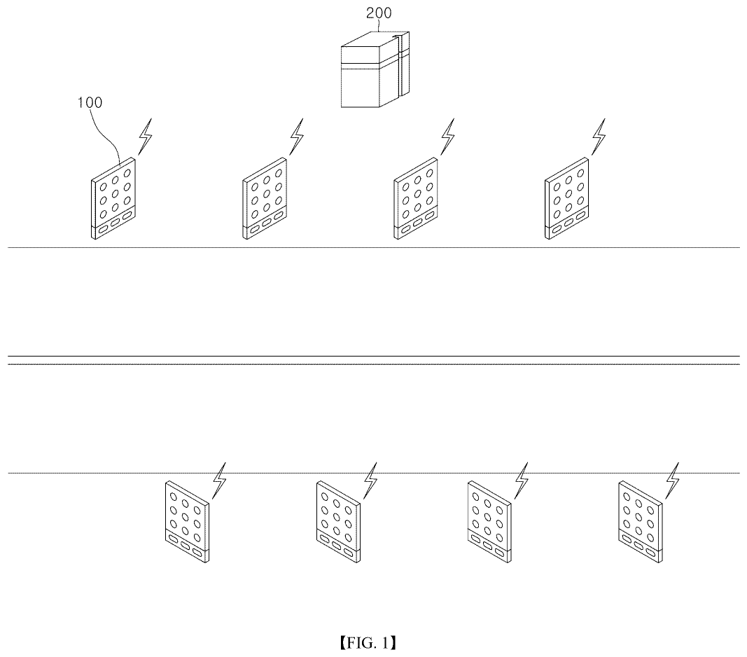

FIG. 1 is a view illustrating a connection configuration between a plurality of road markers and a server included in a road safety system according to an embodiment of the present disclosure.

Referring to FIG. 1, a road safety system according to an embodiment of the present disclosure may include a plurality of road markers 100 and a server 200.

The plurality of road markers 100 are arranged and installed on a road, generate measurement data by measuring various types of information about the road, and can transmit the generated measurement data to the server 200.

In this case, the plurality of road markers 100 may be arranged at predetermined intervals on a road divided into a plurality of measurement regions.

Further, each of the plurality of road markers 100 is disposed in each measurement region and can measure information about the corresponding measurement region.

Further, the server 200 can generate notification information about the road to be provided to the drivers of vehicles traveling on the road on the basis of measurement data received from the plurality of road markers 100 and can transmit the generated notification information to the plurality of road markers 100.

Thereafter, the plurality of road markers 100 can provide the notification information to the drivers of vehicles traveling on the road by outputting the notification information in the form of light in response to the notification information.

Hereafter, the information that is measured by the plurality of road markers 100, the process of generating notification information by the server 200, and the process of outputting notification information by the plurality of road markers 100 are described in detail.

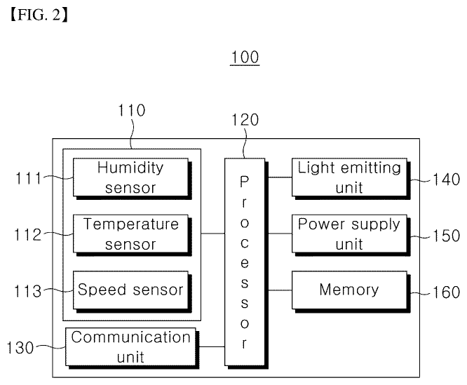

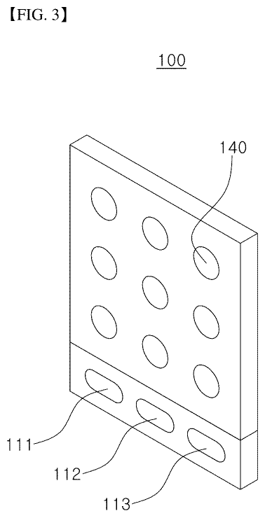

FIG. 2 is a block diagram of a plurality of road markers included in a road safety system according to an embodiment of the present disclosure and FIG. 3 is a perspective view of a plurality of road markers included in a road safety system according to an embodiment of the present disclosure.

Referring further to FIGS. 2 and 3, the plurality of road markers 100 may include a sensor unit 110, a processor 120, a communication unit 130, a light emitting unit 140, a power supply unit 150, and a memory 160.

The sensor unit 110 can measure information about a road and generate the information as data.

Specifically, the sensor unit 110 can measure air humidity in a measurement region of a road on which the road marker 100 is disposed and can generate the measured air humidity as humidity data.

To this end, the sensor unit 110 may include a humidity sensor 111 that periodically measures humidity. Here, the air humidity may be relative humidity.

Meanwhile, the sensor unit 110 can measure air humidity in a measurement region of a road on which the road marker 100 is disposed and can generate the measured air humidity as humidity data.

To this end, the sensor unit 110 may include a humidity sensor 112 that periodically measures humidity. Here, the air temperature may be a temperature in degrees Celsius.

Meanwhile, the sensor unit 110 can output humidity data and temperature data to the processor 120 each time the humidity data and the temperature data are generated.

Subsequently, when the processor 120 receives at least one of humidity data and temperature data from the sensor unit 110, the processor 120 can control the communication unit 130 such that the received humidity data and temperature data are transmitted to the server 200.

In this case, when humidity data is transmitted to the server 200, the processor 120 controls the communication unit 130 such that marker identification information identifying the corresponding road marker 100 is transmitted together with the humidity data, and when temperature data are transmitted to the server 200, the processor 120 can control the communication unit 130 such that marker identification information identifying the corresponding road marker 100 is transmitted together with the temperature data.

Accordingly, the server 200 can receive humidity data and temperature data for each of a plurality of measurement regions in which the plurality of road markers 100 are communicatively connected and disposed.

Meanwhile, when fog notification information is received from the server 200 through the communication unit 130, the processor 120 can control the light emitting unit 140 to output fog alert light in response to the fog notification information.

Further, when icing notification information is received from the server 200 through the communication unit 130, the processor 120 can control the light emitting unit 140 to output icing alert light in response to the icing notification information.

To this end, the communication unit 130 may include a wireless communication interface.

The wireless communication interface can perform communication with various external devices (server) using wireless communication technology or mobile communication technology.

Specifically, the communication unit 130 may include a Long Range (LoRa)-based wireless communication interface and a Message Queuing Telemetry Transport (MQTT)-based wireless communication interface.

Further, the wireless communication technology used in the communication interface 130 may include, for example, Bluetooth, Bluetooth Low Energy, CAN communication, Wi-Fi, Wi-Fi Direct, Ultra Wideband (UWB), ZigBee, Infrared Data Association (IrDA), or Near Field Communication (NFC), and the mobile communication technology may include 3GPP, Wi-Max, Long Term Evolution (LTE), and 5G.

The wireless communication interface may be implemented using an antenna, a communication chip, a circuit board, or the like that can transmit electromagnetic waves to the outside or receive electromagnetic waves transmitted from the outside.

The light emitting unit 140 can provide various types of information to a driver by emitting alert light.

The light emitting unit 140 may include a plurality of light modules to output alert light in various colors and blinking patterns.

Each of the plurality of light modules may be an LED module that outputs light of a plurality of colors.

In this case, the processor 120 can control the light emitting unit 140 to output alert light having a color and a blinking pattern corresponding to notification information.

The control of the light emitting unit 140 by the processor 120 will be described later.

Meanwhile, the processor 120 controls the overall operation of the road marker 100. Specifically, the processor 120 is connected to the configuration of the road marker 100 including the memory 160 as described above, and can generally control the operation of the road marker 100 by executing at least one instruction stored in the memory 160 as described above. In particular, the processor 120 may be implemented not only as a single processor, but also as a plurality of processors.

The processor 120 may be implemented in various ways. For example, one or more processors 120 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 120 can control one or any combination of other components of the road marker 100, and can perform communication-related operations or data processing. The one or more processors 120 can execute one or more programs or instructions stored in the memory 160. For example, the one or more processors 120 can perform a method according to an embodiment of the present disclosure by executing one or more instructions stored in the memory 160.

When the method according to an embodiment of the present disclosure includes a plurality of operations, the plurality of operations may be performed by a single processor 120 or may be performed by a plurality of processors 120. For example, when a first operation, a second operation, and a third operation are performed by the method according to an embodiment, all of the first operation, the second operation, and the third operation may be performed by a first processor, or the first operation and the second operation may be performed by the first processor (for example, a general-purpose processor), and the third operation may be performed by a second processor (for example, an artificial intelligence-dedicated processor).

One or more processors 120 may be implemented as a single-core processor including one core, or may be implemented as one or more multicore processors including a plurality of cores (for example, homogeneous multicore or heterogeneous multicore). When one or more processors 120 are implemented as a multicore processor, each of the plurality of cores included in the multicore processor may include a processor-internal memory such as an on-chip memory 160, and a common cache shared by the plurality of cores may be included in the multicore processor 120. Further, each of the plurality of cores included in the multicore processor 120 (or some of the plurality of cores) may independently read and execute program instructions for implementing the method according to an embodiment of the present disclosure, or all (or some) of the plurality of cores may be linked together and may read and execute program instructions for implementing the method according to an embodiment of the present disclosure.

When the method according to an embodiment of the present disclosure includes a plurality of operations, the plurality of operations may be performed by a single core among a plurality of cores included in a multicore processor, or may be performed by the plurality of cores. For example, when a first operation, a second operation, and a third operation are performed by the method according to an embodiment, all of the first operation, the second operation, and the third operation may be performed by a first core included in the multicore processor, or the first operation and the second operation may be performed by the first core included in the multicore processor, and the third operation may be performed by a second core included in the multicore processor.

In embodiments of the present disclosure, the processor 120 may refer to a System on Chip (SoC) in which one or more processors 120 and other electronic components are integrated, a single-core processor, a multicore processor, or a core included in a single-core processor or a multicore processor, and the core may be implemented as a CPU, a GPU, an APU, a MIC, a DSP, an NPU, a hardware accelerator, or a machine learning accelerator, but the embodiments of the present disclosure are not limited thereto.

The power supply unit 150 can provide driving power for operating the road marker 100.

The power supply unit 150 may be electrically connected to an external power source on a continuous basis to provide the driving power or may include a rechargeable battery to provide the driving power.

In this case, provision of the driving power by the power supply unit 150 may be controlled by the processor 120.

The memory 160 temporarily or non-transitorily stores various programs or data, and delivers stored information to the processor 120 in response to a call from the processor 120. Further, the memory 160 can store, in an electronic format, various types of information required for calculation, processing, or control operations of the processor 120.

The memory 160 may include, for example, at least one of a primary memory and a secondary memory. The primary memory may be implemented using a semiconductor storage medium such as ROM and/or RAM. The ROM may include, for example, a standard ROM, an EPROM, an EEPROM, and/or a MASK-ROM. The RAM may include, for example, a DRAM and/or an SRAM. The secondary memory may be implemented using at least one storage medium capable of permanently or semi-permanently storing data, such as a flash memory device, a Secure Digital (SD) card, a Solid State Drive (SSD), a Hard Disc Drive (HDD), a magnetic drum, an optical recording medium such as a CD, a DVD, or a Laser Disc, a magnetic tape, a magneto-optical disc, and/or a floppy disc.

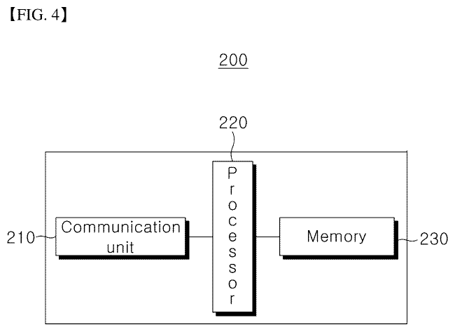

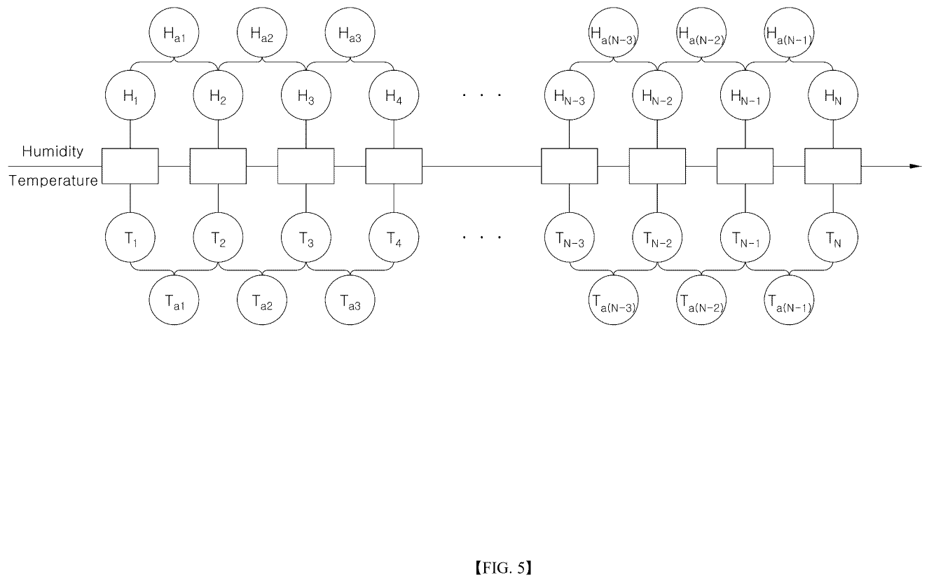

FIG. 4 is a block diagram of a server included in a road safety system according to an embodiment of the present disclosure and FIG. 5 is a view illustrating a process in which a server included in a road safety system according to an embodiment of the present disclosure generates fog notification information and icing notification information.

Referring further to FIGS. 4 and 5, the server 200 may include a communication unit 210, a processor 220, and a memory 230.

The communication unit 210 can receive humidity data and temperature data from the communication units 130 of a plurality of road markers 100.

In this case, when the humidity data and the temperature data are received, the communication unit 210 can output them to the processor 220.

To this end, the communication unit 210 may include a wireless communication interface.

The wireless communication interface can perform communication with various external devices (road marker) using wireless communication technology or mobile communication technology.

Specifically, the communication unit 210 may include a Long Range (LoRa)-based wireless communication interface and a Message Queuing Telemetry Transport (MQTT)-based wireless communication interface.

In addition, the wireless communication technology used in the communication unit 210 may include, for example, Bluetooth, Bluetooth Low Energy, CAN communication, Wi-Fi, Wi-Fi Direct, Ultra Wideband (UWB), ZigBee, Infrared Data Association (IrDA), or Near Field Communication (NFC), and the mobile communication technology may include 3GPP, Wi-Max, Long Term Evolution (LTE), and 5G.

The wireless communication interface may be implemented using an antenna, a communication chip, a circuit board, or the like that can transmit electromagnetic waves to the outside or receive electromagnetic waves transmitted from the outside.

The processor 220 can determine whether the atmospheric state around a road satisfies a fog occurrence condition in which fog occurs, on the basis of humidity data and temperature data received from each of the plurality of road markers 100.

Further, the processor 220 can determine whether the surface of a road satisfies an icing occurrence condition in which the surface of a road freezes, on the basis of humidity data and temperature data received from each of the plurality of road markers 100.

To this end, the processor 220 can calculate an average humidity (Hₐ₁, . . . , H_{a(N-1)}) among air humidities (H₁, . . . , H_{N}) represented by any two or more pieces of humidity data among humidity data received respectively from the plurality of road markers 100, and can generate average humidity data representing the calculated average humidity (Hₐ₁, . . . , H_{a(N-1)}).

In this case, the processor 220 can identify two pieces of humidity data received from two adjacent road markers 100 using marker identification information received together with the humidity data, calculate an average humidity (Hₐ₁, . . . , H_{a(N-1)}) between air humidities (H₁, . . . , H_{N}) represented by the identified two pieces of humidity data, and generate average humidity data representing the calculated average humidity (Hₐ₁, . . . , H_{a(N-1)}).

For example, when eight road markers 100 numbered 1 to 8 are present, the processor 220 can calculate an average humidity (Hₐ₁) between air humidities (H₁, H₂) of humidity data received from the road markers 100 numbered 1 and 2 and can generate average humidity data.

Further, the processor 220 can generate average humidity data for each of the humidity data received from the road markers 100 numbered 2 and 3, the humidity data received from the road markers 100 numbered 3 and 4, the humidity data received from the road markers 100 numbered 4 and 5, the humidity data received from the road markers 100 numbered 5 and 6, the humidity data received from the road markers 100 numbered 6 and 7, and the humidity data received from the road markers 100 numbered 7 and 8.

Meanwhile, the processor 220 can calculate an average temperature (Tₐ₁, . . . , T_{a(N-1)}) between air temperatures (T₁, . . . , T_{N}) represented by any two or more pieces of temperature data among temperature data received respectively from the plurality of road markers 100, and can generate average temperature data representing the calculated average temperature (Tₐ₁, . . . , T_{a(N-1)}).

In this case, the processor 220 can identify two pieces of temperature data received from two adjacent road markers 100 using marker identification information received together with the temperature data, calculate an average temperature (Tₐ₁, . . . , T_{a(N-1)}) between air temperatures (T₁, . . . , T_{N}) represented by the identified two pieces of temperature data, and generate average temperature data representing the calculated average temperature (Tₐ₁, . . . , T_{a(N-1)}).

For example, when eight road markers 100 numbered 1 to 8 are present, the processor 220 can calculate an average temperature (Tₐ₁) between air temperatures (T₁, T₂) of temperature data received from the road markers 100 numbered 1 and 2 and can generate average temperature data.

Further, the processor 220 can generate average temperature data for each of the temperature data received from the road markers 100 numbered 2 and 3, the temperature data received from the road markers 100 numbered 3 and 4, the temperature data received from the road markers 100 numbered 4 and 5, the temperature data received from the road markers 100 numbered 5 and 6, the temperature data received from the road markers 100 numbered 6 and 7, and the temperature data received from the road markers 100 numbered 7 and 8.

In this case, the processor 220 can match the average humidity data and the average temperature data on the basis of the marker identification information of the road markers 100. That is, the processor 220 can identify two pieces of marker identification information received together with two pieces of humidity data used to generate average humidity data, and can match average temperature data, which is generated using two pieces of temperature data received together with the identified two pieces of marker identification information, and the average humidity data.

The processor 220 can determine, for each of the average humidity data and the average temperature data matched through the above-described process, whether a fog occurrence condition and an icing occurrence condition are satisfied.

Hereafter, the fog occurrence condition is described.

The processor 220 can generate dew point data representing a dew point using the matched average humidity data and average temperature data.

Specifically, the processor 220 can generate dew point data by calculating a dew point using Equation 1 below.

### Equation 1

D=T−((100−H)/5)
where D may be a dew point, T may be an average temperature, and H may be an average humidity.

Thereafter, among the matched average humidity data and average temperature data, if the average humidity represented by the average humidity data exceeds a preset fog occurrence condition humidity, and a dew point temperature difference, which is the difference between a dew point represented by dew point data generated from the matched average humidity data and average temperature data and an average temperature represented by the average temperature data, falls within a preset fog occurrence temperature difference range, the processor 220 can determine that the atmospheric state around the road satisfies a fog occurrence condition.

In this case, the fog occurrence condition humidity may be 90% and the fog occurrence temperature difference range may be from −2° C. to 0° C.

On the other hand, among the matched average humidity data and average temperature data, even if the average humidity represented by the average humidity data exceeds the preset fog occurrence condition humidity, if the dew point temperature difference, which is the difference between the dew point represented by the dew point data generated from the matched average humidity data and average temperature data and the average temperature represented by the average temperature data, does not fall within the preset fog occurrence temperature difference range, the processor 220 can determine that an atmospheric state around the road does not satisfy the fog occurrence condition.

Further, among the matched average humidity data and average temperature data, if the average humidity represented by the average humidity data does not exceed the preset fog occurrence condition humidity, even if the dew point temperature difference, which is the difference between the dew point represented by the dew point data generated from the matched average humidity data and average temperature data and the average temperature represented by the average temperature data, falls within the preset fog occurrence temperature difference range, the processor 220 can determine that the atmospheric state around the road does not satisfy the fog occurrence condition.

Further, among the matched average humidity data and average temperature data, if the average humidity represented by the average humidity data does not exceed the preset fog occurrence condition humidity, and the dew point temperature difference, which is the difference between the dew point represented by the dew point data generated from the matched average humidity data and average temperature data and the average temperature represented by the average temperature data, does not fall within the preset fog occurrence temperature difference range, the processor 220 can determine that the atmospheric state around the road does not satisfy the fog occurrence condition.

In this case, the processor 220 can perform the above-described process of determining whether the fog occurrence condition is satisfied for each matched set of average humidity data and average temperature data.

Thereafter, when it is determined that the atmospheric state around the road satisfies the fog occurrence condition, the processor 220 can generate fog occurrence information representing that the atmospheric state around the road satisfies the fog occurrence condition in which fog is generated.

Subsequently, the processor 220 can identify the marker identification information corresponding to the average humidity or the average temperature used when determining that the atmospheric state around the road satisfies the fog occurrence condition, and can control the communication unit 210 such that the fog occurrence information is transmitted to the road marker 100 designated by the identified marker identification information.

Hereafter, the icing occurrence condition is described.

The processor 220 can generate surface temperature data representing a surface temperature of the road by reducing, for all of the temperature data, an average temperature represented by the average temperature data by a preset reduction temperature.

Here, the reduction temperature may be a temperature set within a temperature range of 3° C. to 5° C.

For example, when an average temperature is 2° C. and a reduction temperature is set to 3° C., the processor 220 calculates a surface temperature of −1° C. by reducing the average temperature of 2° C. by the reduction temperature of 3° C., whereby it can generate surface temperature data.

Thereafter, among the matched average humidity data and average temperature data, if the average humidity represented by the average humidity data exceeds a preset icing occurrence condition humidity and a surface temperature represented by surface temperature data generated using the average temperature data is lower than a preset icing reference temperature, the processor 220 can determine that the surface of the road satisfies the icing occurrence condition.

In this case, the icing occurrence condition humidity may be 80% and the icing reference temperature may be 0° C.

On the other hand, among the matched average humidity data and average temperature data, even if the average humidity represented by the average humidity data exceeds the preset icing occurrence condition humidity, if the surface temperature represented by the surface temperature data generated using the average temperature data is equal to or higher than the preset icing reference temperature, the processor 220 can determine that the surface of the road does not satisfy the icing occurrence condition.

Further, among the matched average humidity data and average temperature data, if the average humidity represented by the average humidity data exceeds the preset icing occurrence condition humidity, even if the surface temperature represented by the surface temperature data generated using the average temperature data is lower than the preset icing reference temperature, the processor 220 can determine that the surface of the road does not satisfy the icing occurrence condition.

Further, among the matched average humidity data and average temperature data, if the average humidity represented by the average humidity data does not exceed the preset icing occurrence condition humidity, and the surface temperature represented by the surface temperature data generated using the average temperature data is equal to or higher than the preset icing reference temperature, the processor 220 can determine that the surface of the road does not satisfy the icing occurrence condition.

In this case, the processor 220 can perform the above-described process of determining whether the icing occurrence condition is satisfied for each matched set of average humidity data and average temperature data.

Thereafter, when it is determined that the surface of the road satisfies the icing occurrence condition, the processor 220 can generate icing occurrence information representing that the surface of the road satisfies the icing occurrence condition in which icing occurs.

Subsequently, the processor 220 can identify the marker identification information corresponding to the average humidity or the average temperature used when determining that the surface of the road satisfies the icing occurrence condition, and can control the communication unit 210 such that the icing occurrence information is transmitted to the road marker 100 designated by the identified marker identification information.

Meanwhile, the processor 220 can control the communication unit 210 such that humidity data, temperature data, average humidity data, average temperature data, fog occurrence information, and icing occurrence information are transmitted to a control server.

The processor 220 controls the overall operation of the server 200. Specifically, the processor 220 is connected to the configuration of the server 200 including the memory 230 as described above, and can generally control the operation of the server 200 by executing at least one instruction stored in the memory 230 as described above. In particular, the processor 220 may be implemented not only as a single processor, but also as a plurality of processors.

The processor 220 may be implemented in various ways. For example, one or more processors 220 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 220 can control one or any combination of other components of the server 200, and can perform communication-related operations or data processing. The one or more processors 220 can execute one or more programs or instructions stored in the memory 230. For example, the one or more processors 220 can perform a method according to an embodiment of the present disclosure by executing one or more instructions stored in the memory 230.

When the method according to an embodiment of the present disclosure includes a plurality of operations, the plurality of operations may be performed by a single processor 220 or may be performed by a plurality of processors 220. For example, when a first operation, a second operation, and a third operation are performed by the method according to an embodiment, all of the first operation, the second operation, and the third operation may be performed by a first processor, or the first operation and the second operation may be performed by the first processor (for example, a general-purpose processor), and the third operation may be performed by a second processor (for example, an artificial intelligence-dedicated processor).

One or more processors 220 may be implemented as a single-core processor including one core, or may be implemented as one or more multicore processors including a plurality of cores (for example, homogeneous multicore or heterogeneous multicore). When one or more processors 220 are implemented as a multicore processor, each of the plurality of cores included in the multicore processor may include a processor-internal memory such as an on-chip memory 230, and a common cache shared by the plurality of cores may be included in the multicore processor 220. Further, each of the plurality of cores included in the multicore processor 120 (or some of the plurality of cores) may independently read and execute program instructions for implementing the method according to an embodiment of the present disclosure, or all (or some) of the plurality of cores may be linked together and may read and execute program instructions for implementing the method according to an embodiment of the present disclosure.

When the method according to an embodiment of the present disclosure includes a plurality of operations, the plurality of operations may be performed by a single core among a plurality of cores included in a multicore processor, or may be performed by the plurality of cores. For example, when a first operation, a second operation, and a third operation are performed by the method according to an embodiment, all of the first operation, the second operation, and the third operation may be performed by a first core included in the multicore processor, or the first operation and the second operation may be performed by the first core included in the multicore processor, and the third operation may be performed by a second core included in the multicore processor.

In embodiments of the present disclosure, the processor 220 may refer to a System on Chip (SoC) in which one or more processors 120 and other electronic components are integrated, a single-core processor, a multicore processor, or a core included in a single-core processor or a multicore processor, and the core may be implemented as a CPU, a GPU, an APU, a MIC, a DSP, an NPU, a hardware accelerator, or a machine learning accelerator, but the embodiments of the present disclosure are not limited thereto.

The memory 230 temporarily or non-transitorily stores various programs or data, and delivers stored information to the processor 220 in response to a call from the processor 220. Further, the memory 230 can store, in an electronic format, various types of information required for calculation, processing, or control operations of the processor 220.

The memory 230 may include, for example, at least one of a primary memory and a secondary memory. The primary memory may be implemented using a semiconductor storage medium such as ROM and/or RAM. The ROM may include, for example, a standard ROM, an EPROM, an EEPROM, and/or a MASK-ROM. The RAM may include, for example, a DRAM and/or an SRAM. The secondary memory may be implemented using at least one storage medium capable of permanently or semi-permanently storing data, such as a flash memory device, a Secure Digital (SD) card, a Solid State Drive (SSD), a Hard Disc Drive (HDD), a magnetic drum, an optical recording medium such as a CD, a DVD, or a Laser Disc, a magnetic tape, a magneto-optical disc, and/or a floppy disc.

Meanwhile, when fog occurrence information is received through the communication unit 130, the processor 120 of the road marker 100 can control the light emitting unit 140 to output fog alert light.

In this case, the processor 120 can control the light emitting unit 140 to emit yellow light as fog alert light for a predetermined time at each preset cycle.

Meanwhile, when icing occurrence information is received through the communication unit 130, the processor 120 of the road marker 100 can control the light emitting unit 140 to output icing alert light.

In this case, the processor 120 can control the light emitting unit 140 to emit blue light and red light alternately as icing alert light for a predetermined time at each preset cycle.

Meanwhile, a processor 120 according to another embodiment can set a time point at which fog occurrence information is received as a fog occurrence notification start time point, and can set a period for a preset reference time from a fog occurrence time point as a fog occurrence notification period.

Thereafter, the processor 120 can control the light emitting unit 140 to output fog alert light during the fog occurrence notification period.

Meanwhile, the processor 120 according to another embodiment may set a time point at which icing occurrence information is received as an icing occurrence notification start time point, and can set a period for a preset reference time from an icing occurrence time point as an icing occurrence notification period.

Thereafter, the processor 120 can control the light emitting unit 140 to output icing alert light during the icing occurrence notification period.

Meanwhile, the processor 120 according to another embodiment may, each time the processor 120 sets a fog occurrence notification period and an icing occurrence notification period, if an overlapping period in which the fog occurrence notification period and the icing occurrence notification period overlap is identified, partition the overlapping period into a plurality of first notification periods and a plurality of second notification periods, that is, may partition the overlapping period such that the first notification periods and the second notification periods are adjacent to each other.

For example, the processor 120 according to another embodiment may partition an overlapping period into a first interval of a first notification period, a second interval of the first notification period, a first interval of a second notification period, and a second interval of the second notification period, that is, may set the first interval of the second notification period after the first interval of the first notification period, may set the second interval of the first notification period after the first interval of the second notification period, and may set the second interval of the second notification period after the second interval of the first notification period.

Thereafter, the processor 120 can control the light emitting unit 140 to output fog alert light during the first notification period of the overlapping period, and can control the light emitting unit 140 to output icing alert light during the second notification period of the overlapping period.

In this case, the processor 120 may set a plurality of first notification periods and a plurality of second notification periods such that the total duration of the first intervals of the plurality of first notification periods is shorter than the total duration of the second intervals of the plurality of second notification periods.

Accordingly, the processor 120 can prevent an accident caused by icing, which causes greater accident damage, by controlling the light emitting unit 140 such that icing alert light is output for a longer period than fog alert light during the overlapping period.

Hereafter, a road safety system according to another embodiment is described.

Since the road safety system according to another embodiment further includes only an operation of providing traffic situation information to a driver compared to a road safety system according to one embodiment, repeated descriptions will be omitted.

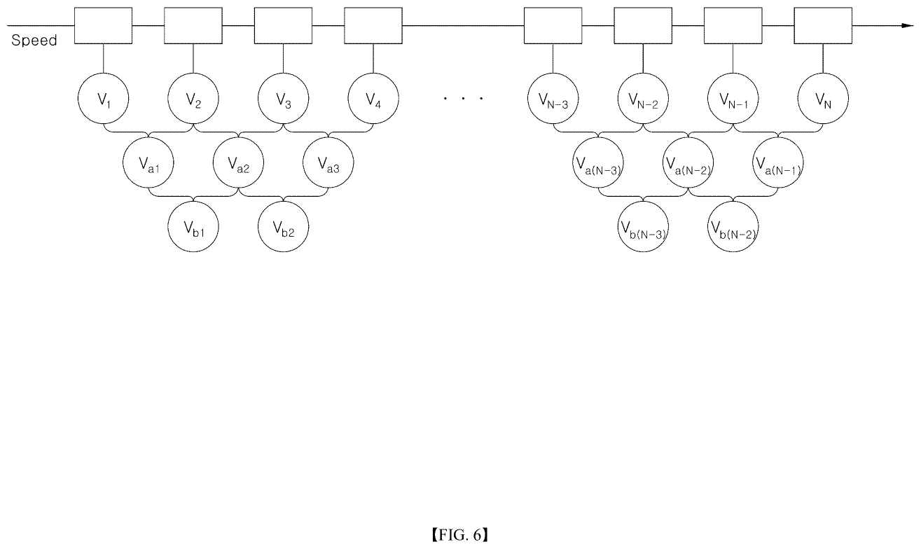

FIG. 6 is a view illustrating a process in which a server included in a road safety system according to another embodiment of the present disclosure generates traffic situation information.

Referring further to FIG. 6, the sensor unit 110 of the plurality of road markers 100 can measure the vehicle speed of a vehicle traveling in a measurement region of a road on which the road marker 100 is disposed, and can generate the measured vehicle speed as speed data.

To this end, the sensor unit 110 may include a speed sensor 113 that measures a vehicle speed. The speed sensor 113 may be implemented as a radar sensor.

Meanwhile, the sensor unit 110 can output speed data to the processor 120 each time a speed is generated.

Subsequently, when the processor 120 receives speed data from the sensor unit 110, the processor 120 can control the communication unit 130 such that the received speed data is transmitted to the server 200.

In this case, when the speed data is transmitted to the server 200, the processor 120 can control the communication unit 130 such that marker identification information for identifying the corresponding road marker 100 is transmitted together with the speed data.

Accordingly, the server 200 can receive speed data for vehicles respectively traveling in a plurality of measurement regions in which the plurality of road markers 100 are disposed and communicatively connected.

Meanwhile, when traffic situation information is received from the server 200 through the communication unit 130, the processor 120 can control the light emitting unit 140 to output traffic situation alert light in response to the traffic situation type indicated by the traffic situation information.

The control of the light emitting unit 140 by the processor 120 will be described later.

The processor 220 can determine, on the basis of speed data received from each of the plurality of road markers 100, which one of a plurality of traffic situation types the traffic situation of the road corresponds to.

To this end, the processor 220 can calculate a first average speed (Vₐ₁, . . . , V_{a(N-1)}) among first vehicle speeds (V₁, . . . , V_{N}) represented by any two or more pieces of speed data among speed data received from the plurality of road markers 100, and can generate first average speed data representing the calculated first average speed (Vₐ₁, . . . , V_{a(N-1)}).

In this case, the processor 220 can identify two pieces of speed data received from two adjacent road markers 100 using marker identification information received together with the speed data, calculate a first average speed (Vₐ₁, . . . , V_{a(N-1)}) among first vehicle speeds (V₁, . . . , V_{N}) represented by the identified two pieces of speed data, and generate first average speed data representing the calculated first average speed (Vₐ₁, . . . , V_{a(N-1)}).

For example, when eight road markers 100 numbered 1 to 8 are present, the processor 220 can generate first average speed data by calculating a first average speed (Vₐ₁) between first vehicle speeds (V₁, V₂) of speed data received from road markers 100 numbered 1 and 2.

Further, the processor 220 can generate first average speed data for each of the speed data received from the road markers 100 numbered 2 and 3, the speed data received from the road markers 100 numbered 3 and 4, the speed data received from the road markers 100 numbered 4 and 5, the speed data received from the road markers 100 numbered 5 and 6, the speed data received from the road markers 100 numbered 6 and 7, and the speed data received from the road markers 100 numbered 7 and 8.

Subsequently, the processor 220 can calculate a second average speed (V_{b1}, . . . , V_{b(N-2)}) among first average speeds (Vₐ₁, . . . , V_{a(N-1)}) represented by any two or more pieces of first average speed data among the first average speed data, and can generate second average speed data representing the calculated second average speed (V_{b1}, . . . , V_{b(N-2)}).

In this case, the processor 220 can calculate a second average speed (V_{b1}, . . . , V_{b(N-2)}) among first vehicle speeds (V₁, . . . , V_{N}) represented by two adjacent pieces of first average speed data on the basis of positions of the road markers 100, and can generate second average speed data representing the calculated second average speed (V_{b1}, . . . , V_{b(N-2)}).

For example, when six road markers 100 numbered 1 to 6 are present, the processor 220 can generate second average speed data by calculating a second average speed (V_{b1}) between a first average speed (Vₐ₁) between first vehicle speeds (V₁, V₂) of speed data received from road markers 100 numbered 1 and 2 and a first average speed (Vₐ₂) between first vehicle speeds (V₂, V₃) of speed data received from road markers 100 numbered 2 and 3.

Further, the processor 220 can generate second average speed data by calculating a second average speed (V_{b2}) between a first average speed (Vₐ₃) between first vehicle speeds (V₃, V ₄) of speed data received from road markers 100 numbered 3 and 4 and a first average speed (Vₐ₄) between first vehicle speeds (V₄, V₅) of speed data received from road markers 100 numbered 4 and 5.

Further, the processor 220 can generate second average speed data by calculating a second average speed (V_{b5}) between a first average speed (Vₐ₄) between first vehicle speeds (V₄, V ₅) of speed data received from road markers 100 numbered 4 and 5 and a first average speed (Vₐ₅) between first vehicle speeds (V₅, V₆) of speed data received from road markers 100 numbered 5 and 6.

Meanwhile, the processor 220 can match marker identification information received together with the speed data used to generate the second average speed data to the second average speed data.

Subsequently, the processor 220 can determine, for each of the second average speed data generated through the above-described process, which one of a plurality of traffic situation types the data corresponds to.

Specifically, the processor 220 can identify, among reference speed ranges preset for a plurality of traffic situation types, respectively, a reference speed range that includes the second average speed represented by second average speed data.

Subsequently, the processor 220 can generate traffic situation information indicating that the traffic situation type for which the identified reference speed range is set is the traffic situation of the road.

Here, the plurality of traffic situation types may be composed of “congestion,” “slow traffic,” and “smooth traffic.”

A reference speed range of 0 km/h or higher and 40 km/h or lower is set for the traffic situation type “congestion,” a reference speed range of greater than 40 km/h and 80 km/h or lower is set for the traffic situation type “slow traffic,” and a reference speed range of greater than 80 km/h may be set for the traffic situation type “smooth traffic,” but the number of traffic situation types and the reference speed ranges may be variously changed.

Subsequently, the processor 220 can identify the marker identification information of the road marker 100 corresponding to the second average speed used to determine which traffic situation type among a plurality of traffic situation types the traffic situation of the road corresponds to, and can control the communication unit 210 such that traffic situation information is transmitted to the road marker 100 designated by the identified marker identification information.

Further, the processor 220 can control the communication unit 210 such that not only traffic situation information but also second average speed data is transmitted to the road marker 100 indicated by the identified marker identification information.

Continuing with the above-described example, when a second average speed (V_{b1}) between a first average speed (Vₐ₁) between first vehicle speeds (V₁, V₂) of speed data received from the road markers 100 numbered 1 and 2 and a first average speed (Vₐ₂) between first vehicle speeds (V₂, V₃) of speed data received from the road markers 100 numbered 2 and 3 is calculated as 10 km/h and falls within a reference speed range set for the traffic situation type “congestion,” the processor 220 can identify marker identification information of each of the road markers 100 numbered 1 to 3 matched to second average speed data representing the second average speed (V_{b1}).

Meanwhile, the processor 220 can control the communication unit 210 such that speed data, first average speed data, second average speed data, and traffic situation information are transmitted to the control server.

Meanwhile, when traffic situation information is received through the communication unit 130, the processor 120 of the road marker 100 can control the light emitting unit 140 to output traffic situation alert light in response to the traffic situation type indicated by the traffic situation information.

In this case, when the traffic situation type indicated by the traffic situation information is “congestion,” the processor 120 can control the light emitting unit 140 such that red light is output as traffic situation alert light.

Further, when the traffic situation type indicated by the traffic situation information is “slow traffic,” the processor 120 can control the light emitting unit 140 such that yellow light is output as traffic situation alert light.

When the traffic situation type indicated by the traffic situation information is “smooth traffic,” the processor 120 can control the light emitting unit 140 such that green light is output as traffic situation alert light.

Meanwhile, when traffic situation information is received, the processor 120 according to another embodiment can compare the traffic situation type of previously received traffic situation information with the traffic situation type of most recently received traffic situation information. In this case, if the traffic situation type of the previously received traffic situation information and the traffic situation type of the most recently received traffic situation information are different, the processor 120 can control the light emitting unit 140 such that traffic situation alert light corresponding to the most recently received traffic situation information is output only when the time difference between a first reception time point of the most recently received traffic situation information and a second reception time point of the previously received traffic situation information exceeds a reference time difference.

In this case, the processor 120 according to another embodiment can set a reference time difference in accordance with second average speed data received together with traffic situation information each time traffic situation information is received.

Specifically, the processor 120 according to another embodiment calculates an average speed difference between a second average speed represented by second average speed data received together with traffic situation information at a first reception time point and a second average speed represented by second average speed data received together with traffic situation information at a second reception time point, calculates a correction rate corresponding to the absolute value of the calculated average speed difference, and calculates a reference time difference by applying the calculated correction rate to a base time difference, whereby it can set a reference time difference.

In this case, the processor 120 according to another embodiment can calculate the correction rate such that the greater the absolute value of the average speed difference, the smaller the correction rate.

Here, the correction rate may be a value within a range of 0% to 100%.

For example, when a base time difference is 10 seconds and the absolute value of an average speed difference is 30 km/h, the processor 120 according to another embodiment can calculate and set a reference time difference as 8 seconds by calculating a correction rate as 80% and applying the correction rate to the base time difference of 10 seconds.

On the other hand, when a base time difference is 10 seconds and the absolute value of an average speed difference is 60 km/h, the processor 120 according to another embodiment can calculate and set a reference time difference as 4 seconds by calculating a correction rate as 40% and applying the correction rate to the base time difference of 10 seconds.

That is, as variation of a second average speed becomes greater, the processor 120 according to another embodiment sets a reference time difference to be shorter, whereby it is possible to prevent an accident by more quickly reflecting a change in traffic situation information. Further, as variation of the second average speed becomes smaller, the processor 120 sets the reference time difference to be longer, whereby it is possible to prevent drivers from being confused by preventing rapid and frequent changes in traffic situation information.

Although preferred embodiments of the present disclosure were illustrated in the drawings and described above, the present disclosure is not limited to specific embodiments and may be modified in various ways by those skilled in the art without departing from the scope of the present disclosure described in claims, and the modified examples should not be construed independently from the spirit or the scope of the present disclosure.

What is claimed is:

1. A road safety system comprising:
a plurality of road markers installed on a road, and configured to generate humidity data by measuring air humidity and generate temperature data by measuring air temperature; and
a server configured to receive the humidity data and the temperature data from each of the plurality of road markers, generate fog occurrence information indicating that an atmospheric state around the road satisfies a fog occurrence condition on the basis of the humidity data and the temperature data, and generate icing occurrence information indicating that a surface of the road satisfies an icing occurrence condition on the basis of the humidity data and the temperature data,
wherein each of the plurality of road markers outputs fog alert light when the fog occurrence information is received from the server and outputs icing alert light when the icing occurrence information is received from the server.

2. The road safety system of claim 1, wherein the server generates average humidity data representing an average humidity between air humidities represented by any two or more pieces of humidity data among the plurality of humidity data, and generates average temperature data representing an average temperature between air temperatures represented by any two or more pieces of temperature data among the plurality of temperature data.

3. The road safety system of claim 2, wherein the server generates dew point data representing a dew point using the average humidity data and the average temperature data, and
when the average humidity represented by the average humidity data exceeds a preset fog occurrence condition humidity and a dew point temperature difference, which is a difference between the dew point represented by the dew point data and an average temperature represented by the average temperature data, falls within a preset fog occurrence temperature difference range, the server determines that the atmospheric state of the road satisfies the fog occurrence condition, and generates the fog occurrence information.

4. The road safety system of claim 3, wherein the server identifies marker identification information of a road marker corresponding to the average humidity or the average temperature used to determine that the atmospheric state of the road satisfies the fog occurrence condition, and transmits the fog occurrence information to the road marker indicated by the identified marker identification information.

5. The road safety system of claim 2, wherein the server generates surface temperature data representing a surface temperature of the road by reducing an average temperature represented by the average temperature data by a preset reduction temperature, and
when the average humidity represented by the average humidity data exceeds a preset icing occurrence condition humidity and the surface temperature represented by the surface temperature data is lower than a preset icing reference temperature, the server determines that the surface of the road satisfies the icing occurrence condition, and generates the icing occurrence information.

6. The road safety system of claim 5, wherein the server identifies marker identification information of a road marker corresponding to the average humidity or the average temperature used to determine that the surface of the road satisfies the icing occurrence condition, and transmits the icing occurrence information to the road marker indicated by the identified marker identification information.

7. The road safety system of claim 1, wherein the plurality of road markers include:
a sensor unit including a humidity sensor configured to measure air humidity and a temperature sensor configured to measure air temperature; and
a light emitting unit configured to output one or more of fog alert light and icing alert light.
